(19) United States
(12) Patent Application Publication
(10) Pub. No.: US 2023/0147625 A1
(43) Pub. Date: May 11, 2023

(54) CASTER WHEEL ANTI-OSCILLATION MECHANISM

(71) Applicant: Radio Flyer Inc., Chicago, IL (US)

(72) Inventor: Agostino LoBello, Chicago, IL (US)

(21) Appl. No.: 17/980,874

(22) Filed: Nov. 4, 2022

Related U.S. Application Data
(60) Provisional application No. 63/276,013, filed on Nov. 5, 2021.

(51) Int. Cl. B60B 33/04

(52) U.S. Cl. CPC B60B 33/045

(57) ABSTRACT

An anti-oscillation mechanism is provided for a caster wheel assembly of a ride-on vehicle. The anti-oscillating mechanism has a stop, a first cap, a second cap and a bias member. The stop is positioned within the frame of the ride-on vehicle. The first cap has a wall that abuts the stop. The second cap has a wall that abuts a stem of the caster wheel assembly. The bias member has a first end that engages the first cap, and a second end that engages the second cap. The bias member exerts a force on the second cap, which exerts a force on the stem to push the caster wheel assembly toward a ground to help prevent a wheel of the caster wheel assembly from lifting off the ground.

### CROSS-REFERENCE TO RELATED APPLICATIONS

This application claims the benefit of U.S. Provisional Patent Application No. 63/276,013 filed Nov. 5, 2021, which is expressly incorporated herein by reference and made a part hereof.

### FEDERALLY SPONSORED RESEARCH OR DEVELOPMENT

Not Applicable.

### TECHNICAL FIELD

The present subject matter relates to an anti-oscillation mechanism, and more particularly, to an anti-oscillation mechanism for a caster wheel.

### BACKGROUND

Anti-oscillation mechanisms are known in the art. While such mechanisms according to the prior art provide a number of advantages, they nevertheless have certain limitations. The present disclosure seeks to overcome certain of those limitations and other drawbacks of the prior art, and to provide new features not heretofore available. A full discussion of the features and advantages of the present disclosure is deferred to the following detailed description, which proceeds with reference to the accompanying drawings.

### SUMMARY

According to certain aspects of the present disclosure, the disclosed subject technology relates to an anti-oscillation mechanism for a ride-on vehicle.

The disclosed technology further relates to an anti-oscillation mechanism for a caster wheel assembly of a ride-on vehicle having a frame, the caster assembly having a stem, the anti-oscillating mechanism comprising: a stop provided within an opening in the frame of the ride-on vehicle; a first cap having a first receiver and a wall that abuts the stop, the first cap being located within the opening in the frame; a second cap having a second receiver and a wall that abuts the stem, the second cap being located within the opening in the frame; a bias member having a first end and a second end, the bias member being located within the opening in the frame, the first end being received in the first receiver of the first cap and the second end being received in the second receiver of the second cap, the bias member exerting a force on the second cap which exerts a force on the stem to push the caster wheel assembly toward a ground to help prevent a wheel of the caster wheel assembly from lifting off the ground.

The disclosed technology further relates to an anti-oscillation mechanism for a caster wheel assembly of a ride-on vehicle having a frame, the caster assembly having a stem, the anti-oscillating mechanism comprising: a stop within the frame of the ride-on vehicle; a first cap having a wall that abuts the stop; a second cap having a wall that abuts the stem; a bias member having a first end and a second end, the first end engaging the first cap and the second end engaging the second cap, the bias member exerting a force on the second cap which exerts a force on the stem to push the caster wheel assembly toward a ground to help prevent a wheel of the caster wheel assembly from lifting off the ground.

The disclosed technology further relates to an anti-oscillation mechanism for a caster wheel assembly of a ride-on vehicle having a frame, the caster assembly having a stem, the anti-oscillating mechanism comprising: a stop extending through a hole in the frame of the ride-on vehicle and extending within an opening in the frame; a first cap having a wall that abuts the stop; a second cap having a wall that abuts the stem; a bias member having a first end and a second end, the first end engaging the first cap and the second end engaging the second cap, the bias member exerting a force on the second cap which exerts a force on the stem to push the caster wheel assembly toward a ground to help prevent a wheel of the caster wheel assembly from lifting off the ground.

The disclosed technology further relates to an anti-oscillation mechanism, wherein the first cap is positioned against the stop, the second cap is positioned against the stem of the caster wheel assembly, and the spring is positioned between the first cap and the second cap.

The disclosed technology further relates to an anti-oscillation mechanism, wherein the stop is positioned within a hole in the frame.

The disclosed technology further relates to an anti-oscillation mechanism, wherein the bias member is a compression spring.

The disclosed technology further relates to an anti-oscillation mechanism, wherein the stop is a rivet.

The disclosed technology further relates to an anti-oscillation mechanism, wherein the first cap has a first receiver and wherein the first end of the bias member is positioned within the first receiver.

The disclosed technology further relates to an anti-oscillation mechanism, wherein the second cap has a second receiver and wherein the second end of the bias member is positioned within the second receiver.

The disclosed technology further relates to an anti-oscillation mechanism, wherein the first cap, second cap and bias member are all located within the opening in the frame of the ride-on vehicle.

The disclosed technology further relates to an anti-oscillation mechanism, wherein a hole is provided in the frame, and wherein the stop is positioned within the hole in the frame.

The disclosed technology further relates to an anti-oscillation mechanism, wherein the stop provides an upper limit for the anti-oscillation mechanism within the opening in the frame.

It is understood that other embodiments and configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

To understand the present disclosure, it will now be described by way of example, with reference to the accompanying drawings in which embodiments of the disclosures are illustrated and, together with the descriptions below are incorporated in and constitute a part of this specification, and serve to explain the principles of the disclosure. In the drawings:

FIG. 1 is a front perspective view of a wagon having an anti-oscillation mechanism according to the present disclosure.

FIG. 2 is an enlarged front perspective view of the wagon of FIG. 1 having an anti-oscillation mechanism according to the present disclosure.

FIG. 3 is a partial transparent front perspective view of the wagon of FIG. 1 having an anti-oscillation mechanism according to the present disclosure.

FIG. 4 is an exploded perspective view of an anti-oscillation mechanism according to the present disclosure.

FIG. 5 is a perspective view of one embodiment of a portion of the wagon of FIG. 1 having an anti-oscillation mechanism according to the present disclosure.

FIG. 6 is a partial front cross-sectional view of the wagon of FIG. 1 having an anti-oscillation mechanism according to the present disclosure.

FIG. 7 is a partial side cross-sectional view of the wagon of FIG. 1 having an anti-oscillation mechanism according to the present disclosure.

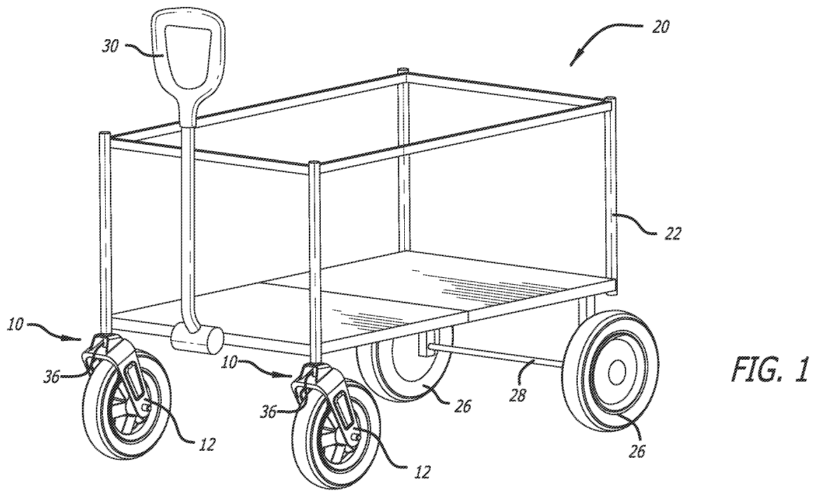

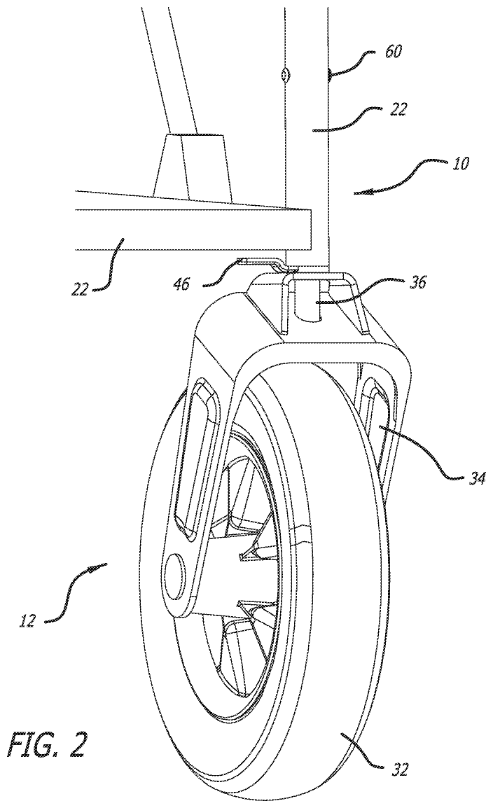

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

While this disclosure is susceptible of embodiments in many different forms, there is shown in the drawings and will herein be described in detail preferred embodiments with the understanding that the present disclosure is to be considered as an exemplification of the principles of the disclosure and is not intended to limit the broad aspect of the disclosure to the embodiments illustrated. It should be noted that the features illustrated in the drawings are not necessarily drawn to scale, and features of one embodiment may be employed with other embodiments as one of ordinary skill in the relevant art would recognize, even if not explicitly stated herein. Further, descriptions of well-known components and processing techniques may be omitted so as to not unnecessarily obscure the embodiments of the present disclosure. The examples used herein are intended merely to facilitate an understanding of ways in which the present disclosure may be practiced and to further enable those of ordinary skill in the art to practice the embodiments of the present disclosure. Accordingly, the examples and embodiments herein should not be construed as limiting the scope of the present disclosure, which is defined solely by the appended claims and applicable law.

Generally, this disclosure describes various embodiments of an anti-oscillation mechanism 10 for a caster wheel assembly 12. In one embodiment, the caster wheel 12 and anti-oscillation mechanism 10 are utilized for a ride-on vehicle 20, such as a wagon 20. In one embodiment the wagon 20 has a frame 22, also referred to as a housing 22, two front caster wheel assemblies 12, two rear wheels 26 typically connected with a solid rear axle 28, although the solid rear axle 28 is not required, and a pull handle 30. With a wagon, because there are typically two front caster wheel assemblies 12, there will typically be two anti-oscillation mechanisms 10, one anti-oscillation mechanism 10 for each caster wheel assembly 12.

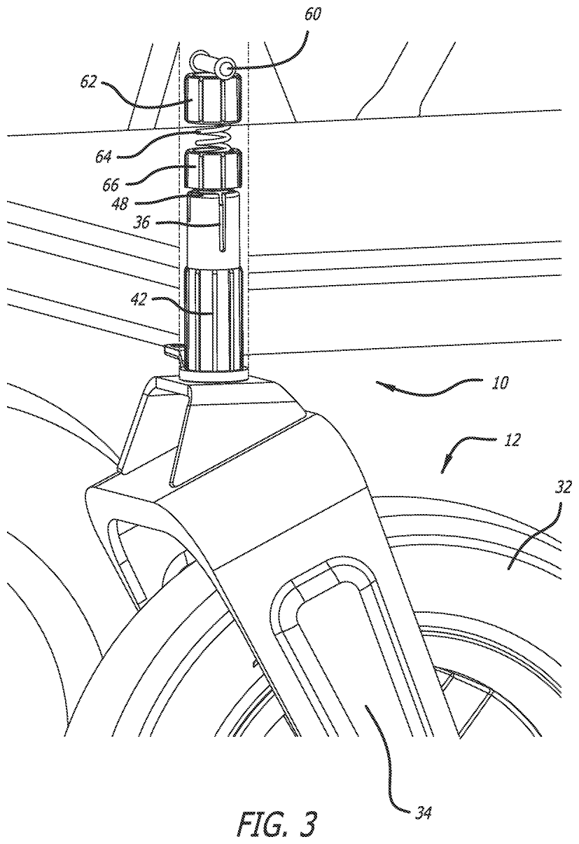

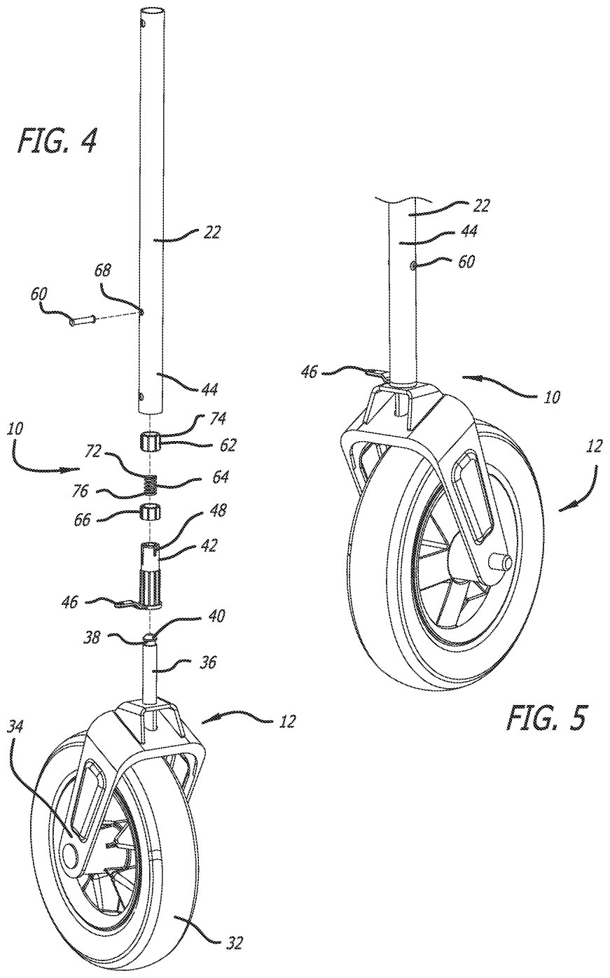

Referring to FIGS. 3 and 4, each caster wheel assembly 12 generally comprises a wheel 32, a fork 34 and a stem 36. In one embodiment the stem 36 of the caster wheel assembly 12 has a groove 38 toward a top end 40 of the stem 36. In one embodiment, the stem 36 is located within the opening 52 in the frame 22, such as within a tube of the frame 22. Additionally, a bushing 42 is provided to secure the caster wheel assembly 12 to the frame 22 of the wagon 20. In one embodiment the bushing 42 pivotally secures the stem 36 of the caster wheel assembly 12 within a tube 44 of the frame 22, and in another embodiment a flange 46 of the bushing 42 is secured to the wagon frame 22 to assist in preventing the caster wheel assembly 12 from being displaced from the wagon frame 22. In one embodiment, the bushing 42 has a fingers 48 that engage in a spring-like manner the groove 38 of the stem 36. The bushing 42 typically is fitted on the stem 36 of the caster wheel assembly 12 and “locked” onto the stem 36 in a snap-fit manner by the fingers 48 engaging the groove 38 of the stem 36. The stem 36 is thus able to rotate within the bore 50 of the bushing 42. The stem 36 and bushing 42 are then fitted into an opening 52 in the frame 22, such as an opening 52 in a tube 44 of the frame 22. The bushing 42 is typically designed to be press fit into the opening 52 to secure the caster wheel assembly 12 to the frame 22. In one embodiment, however, the flange 46 of the bushing 42 is secured to the frame 22 with a fastener to further assist in preventing the caster wheel assembly 12 from being disassociated from the frame 22. Preferably, a separate anti-oscillation mechanism 10 is provided for each caster wheel assembly 20 to separately bias each caster wheel assembly 12 toward the ground and away from the frame 22.

Referring to the figures, and initially to FIGS. 3 and 4, there is shown an embodiment of an anti-oscillation mechanism 10. In one embodiment, the anti-oscillation mechanism 10 comprises a stop 60, a first cap 62, a bias member 64 and a second cap 66. As shown in FIGS. 3, 6 and 7, the anti-oscillation mechanism 10 sits on top of the stem 36 of the caster wheel assembly 12. Because of variances in tolerances between the fingers 48 of the bushing 42 and the groove 38 of the stem 36, as well as variances in tolerances of the frame 22 itself, the stem 36 of the caster wheel assembly 12 may have some play and be able to slightly move longitudinally within the bore 50 of the bushing 42 and within the opening 52 of the frame 22. Thus, the anti-oscillation mechanism 10 provides a downward bias or force on the stem 36 of the caster wheel assembly 12 to push the caster wheel assembly 12 toward the ground to help prevent the wheel 32 of the caster wheel assembly 12 from lifting off the ground.

Referring to FIGS. 4-7, in one embodiment, the stop 60 is provided within the opening 52 of the frame 22. In one embodiment, the stop 60 is a rivet. In one embodiment, holes 68 are provided in the frame 22 and the stop 60 is inserted through the holes 68 and secured in place within the opening 52 in the frame 22. The stop 60 provides an upper limit for the anti-oscillation mechanism 10.

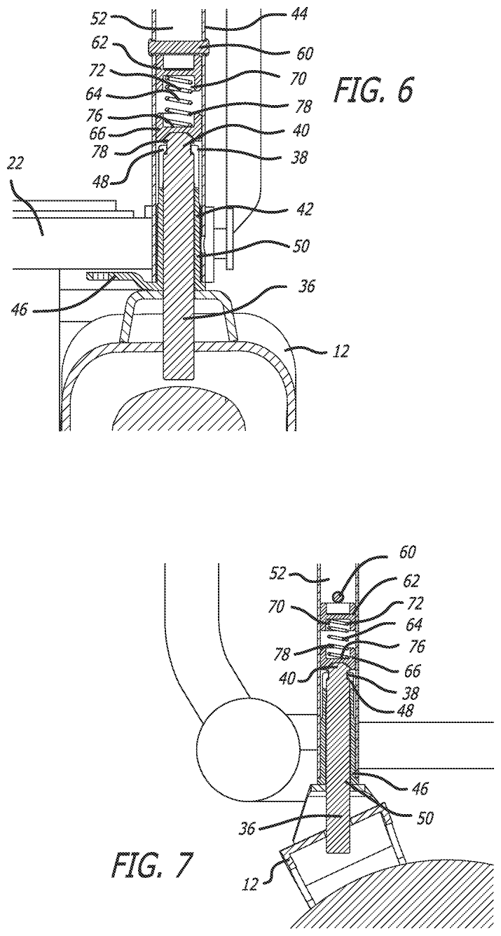

As shown in FIGS. 3-4 and 6-7, in one embodiment the first cap 62 is provided adjacent the stop 60. In different embodiments the first cap 62 can provide different structure and function for the anti-oscillation mechanism 10. In one embodiment, the first cap 62 operates a retainer for a first end 72 of the bias member 64. In another embodiment, the first cap 62 operates as a stop for the first end 72 of the bias member 64. Referring to the first cap 62 shown in FIGS. 6 and 7, the first cap 62 has a receiver 70 for receiving the first end 72 bias member 64 and retaining the first end 72 of the bias member 64 as well as operating as a stop for the first end 72 of the bias member 64. The first cap 62 also has a wall 74 that abuts the stop 60. In one embodiment, the first cap 62 is located within the opening in the frame.

Also as shown in FIGS. 3-4 and 6-7, in one embodiment the second cap 66 is provided adjacent the top end 40 of the stem 36 of the caster wheel assembly 12. In different embodiments the second cap 66 can provided different structure and function for the anti-oscillating mechanism 10. In one embodiment, the second cap 66 operates as a retainer for a second end 76 of the bias member 64. In another embodiment, the second cap 66 operates as a stop for the second end 76 of the bias member 64. Referring to the second cap 66 shown in FIGS. 6 and 7, the second cap 66 has a receiver 78 for receiving the second end 76 of the bias member 64 and retaining the second end 76 of the bias member 64, as well as operating as a stop for the second end 76 of the bias member 64. The second cap 66 also has a wall 78 that abuts the top end 40 of the stem 26 of the caster wheel assembly 12. The wall 78 of the second cap 66 may have a flat geometry or it may have a mating geometry to the top end 40 of the stem 26. In one embodiment, the second cap 66 is located within the opening in the frame.

In one embodiment, the bias member 64 is a spring. And, in a preferred embodiment the bias member 64 is a compression spring. The bias member 64 typically exerts a force on both the first cap 64 and the second cap 66, however, since the first cap 64 is located against the stop 60, the bias member 64 operates to push the second cap 66 downwardly against the stem 26 to force the stem 26, and thus the entire caster wheel assembly 12, against the floor. In one embodiment, the bias member 64 is located within the opening in the frame.

The embodiments detailed hereinabove may be combined in full or in part, with any alternative embodiments described.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and claims, is utilized in an open-ended manner.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

It will be understood that the present disclosure may be embodied in other specific forms without departing from the spirit or central characteristics thereof. The present examples and embodiments, therefore, are to be considered in all respects as illustrative and not restrictive, and the Claims are not to be limited to the details given herein. Accordingly, while the specific embodiments have been illustrated and described, numerous modifications come to mind without significantly departing from the spirit of the disclosure and the scope of protection is only limited by the scope of the accompanying Claims.

Further, the claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An anti-oscillation mechanism for a caster wheel assembly of a ride-on vehicle having a frame, the caster assembly having a stem, the anti-oscillating mechanism comprising:
a stop provided within an opening in the frame of the ride-on vehicle;
a first cap having a first receiver and a wall that abuts the stop, the first cap being located within the opening in the frame;
a second cap having a second receiver and a wall that abuts the stem, the second cap being located within the opening in the frame;
a bias member having a first end and a second end, the bias member being located within the opening in the frame, the first end being received in the first receiver of the first cap and the second end being received in the second receiver of the second cap, the bias member exerting a force on the second cap which exerts a force on the stem to push the caster wheel assembly toward a ground to help prevent a wheel of the caster wheel assembly from lifting off the ground.

2. The anti-oscillation mechanism of claim 1, wherein the first cap is positioned against the stop, the second cap is positioned against the stem of the caster wheel assembly, and the spring is positioned between the first cap and the second cap.

3. The anti-oscillation mechanism of claim 1, wherein the stop is positioned within a hole in the frame.

4. The anti-oscillation mechanism of claim 1, wherein the bias member is a compression spring.

5. The anti-oscillation mechanism of claim 1, wherein the stop is a rivet.

6. An anti-oscillation mechanism for a caster wheel assembly of a ride-on vehicle having a frame, the caster assembly having a stem, the anti-oscillating mechanism comprising:
a stop within the frame of the ride-on vehicle;
a first cap having a wall that abuts the stop
a second cap having a wall that abuts the stem;
a bias member having a first end and a second end, the first end engaging the first cap and the second end engaging the second cap, the bias member exerting a force on the second cap which exerts a force on the stem to push the caster wheel assembly toward a ground to help prevent a wheel of the caster wheel assembly from lifting off the ground.

7. The anti-oscillation mechanism of claim 6, wherein the first cap has a first receiver and wherein the first end of the bias member is positioned within the first receiver.

8. The anti-oscillation mechanism of claim 6, wherein the second cap has a second receiver and wherein the second end of the bias member is positioned within the second receiver.

9. The anti-oscillation mechanism of claim 6, wherein the first cap, second cap and bias member are all located within the opening in the frame of the ride-on vehicle.

10. The anti-oscillation mechanism of claim 6, wherein the bias member is a compression spring.

11. The anti-oscillation mechanism of claim 6, wherein the stop is a rivet.

12. The anti-oscillation mechanism of claim 6, wherein a hole is provided in the frame, and wherein the stop is positioned within the hole in the frame.

13. The anti-oscillation mechanism of claim 6, wherein the stop provides an upper limit for the anti-oscillation mechanism within the opening in the frame.

14. An anti-oscillation mechanism for a caster wheel assembly of a ride-on vehicle having a frame, the caster assembly having a stem, the anti-oscillating mechanism comprising:
a stop extending through a hole in the frame of the ride-on vehicle and extending within an opening in the frame;
a first cap having a wall that abuts the stop;
a second cap having a wall that abuts the stem;
a bias member having a first end and a second end, the first end engaging the first cap and the second end engaging the second cap, the bias member exerting a force on the second cap which exerts a force on the stem to push the caster wheel assembly toward a ground to help prevent a wheel of the caster wheel assembly from lifting off the ground.

15. The anti-oscillation mechanism of claim 14, wherein the first cap has a first receiver and wherein the first end of the bias member is positioned within the first receiver.

16. The anti-oscillation mechanism of claim 15, wherein the second cap has a second receiver and wherein the second end of the bias member is positioned within the second receiver.

17. The anti-oscillation mechanism of claim 16, wherein the first cap, second cap and bias member are all located within the opening in the frame of the ride-on vehicle.

18. The anti-oscillation mechanism of claim 14, wherein the bias member is a compression spring.

19. The anti-oscillation mechanism of claim 14, wherein the stop is a rivet.

20. The anti-oscillation mechanism of claim 14, wherein the stop provides an upper limit for the anti-oscillation mechanism within the opening in the frame.
